(19) United States
(12) Patent Application Publication
(10) Pub. No.: US 2023/0279171 A1
(43) Pub. Date: Sep. 7, 2023

(54) POLYMER LATEX

(71) Applicant: Synthomer Sdn. Bhd., Johor Darul Takzim (MY)

(72) Inventors: Zhenli Wei, Johor Darul Takzim (MY); Yi-Fan Goh, Johor Darul Takzim (MY); Chi Hoong Chan, Johor Darul Takzim (MY)

(73) Assignee: Synthomer Sdn. Bhd., Johor Darul Takzim (MY)

(21) Appl. No.: 18/013,787

(22) PCT Filed: Jun. 25, 2021
(86) PCT No.: PCT/MY2021/050051

§ 371 Date: Dec. 29, 2022

(30) Foreign Application Priority Data
Jul. 7, 2020 (MY) PI 2020003518

(51) Int. Cl. C08F 236/12; C08K 5/103; C08J 5/12; C09D 5/02; C09D 147/00; C09D 7/63; B29C 41/00; B29C 41/34

(52) U.S. Cl. CPC C08F 236/12; B29C 41/003; B29C 41/34; C08J 5/121; C08K 5/103; C09D 5/022; C09D 7/63; C09D 147/00; B29C 41/14; C08F 2810/20; C08J 2347/00

(57) ABSTRACT

The present invention relates to a polymer latex comprising:
(A) particles of a latex polymer (A) obtainable by free-radical emulsion polymerization of a mixture of ethylenically unsaturated monomers the latex polymer comprising a plurality of functional groups (x); and
(B) a compound bearing a beta-hydroxy ester linkage and at least one additional functional group (y) reactive with the functional groups (x) on latex polymer (A),
to a method for preparation of said polymer latex, to its use, to a method for dip-molding and to articles obtained from the latex.

### CROSS REFERENCE TO RELATED APPLICATION

This application is a National Phase application of International Application No. PCT/MY2021/050051, filed Jun. 25, 2021 which claims priority to and the benefit of Malaysian Application No. PI 2020003518, filed Jul. 7, 2020, the entire disclosure of each of which is incorporated herein by reference for all purposes.

### FIELD OF THE INVENTION

The present invention relates to a polymer latex, to a method for the preparation of such a polymer latex, to the use of said polymer latex for the production of elastomeric articles, for coating or impregnating a substrate, to a compounded latex composition comprising said polymer latex.

### BACKGROUND OF THE INVENTION

In the art of making articles based on a polymer latex it is in general desired to achieve a high tensile strength and at the same time high elongation of the film forming the article to provide high mechanical strength and desired softness to the article. This is particularly important for surgical gloves. Furthermore, in the recent past it was discovered that a growing number of persons show allergic reactions to latex based articles, for example a natural rubber latex that has been used commonly in the past in the manufacturing of latex products such as dip molded product contains up to 5% of non-rubber components such as proteins, lipids and trace elements. Users of natural rubber latex products have developed Type-I hypersensitivity which is caused by the residual extractable latex proteins present in natural rubber products.

Natural as well as artificially made polymer latices are commonly crosslinked using a sulfur vulcanization system including sulfur and sulfur-containing accelerators. The use of these sulfur vulcanization systems in rubber gloves manufacturing can give rise to the delay Type-IV hypersensitivity such as allergic contact dermatitis.

As a result, in the prior art several attempts were made to avoid sulfur vulcanization systems and particularly to provid\e polymer latices that can be used for the manufacture of dip-molded articles that do not need the standard sulfur vulcanization systems including the sulfur-containing accelerators previously used therein in order to obtain the desired mechanical properties of the final product.

US 7,345,111 relates to an acrylic polymer emulsion and gloves formed from this emulsion. The polymer is formed by polymerization of 100% by weight in total of a monomeric mixture comprising 50 to 90% by weight of an alkyl acrylate or an alkyl methacrylate, 9 to 49% by weight of a vinyl monomer, the homopolymer thereof has a glass transition temperature of not lower than 80° C., 0.2 to 100% by weight of a vinyl monomer having a carboxyl group, and 0.1 to 5% by weight of a crosslinkable monomer, which is poly(tetramethyleneether) glycol diglycidyl ether having a molecular weight of no less than 280.

US 8,975,351 discloses a latex resin composition for rubber gloves without sulfur and vulcanization accelerators. The composition comprises a conjugated diene monomer, an ethylenically unsaturated nitrile monomer, an ethylenically unsaturated acid monomer, an ethylenically unsaturated monomer copolymerizable with the ethylenically unsaturated nitrile monomer and the ethylenically unsaturated acid monomer, and a reactive compound which includes two or more reactive groups. Examples of these compounds are polyether glycol diglycidyl ethers.

Similarly, US 8,044,138 discloses a carboxylic acid-modified nitrile copolymer latex prepared from, as constituent monomers, a conjugated diene monomer, an ethylenically unsaturated nitrile monomer, an ethylenically unsaturated acid monomer, and an unsaturated monomer having at least one crosslinkable functional group selected from vinyl or epoxy groups. In the examples, glycidyl methacrylate is inter alia used as monomer having at least one crosslinkable functional group.

WO 2017/209596 discloses a polymer latex for dip-molding applications comprising two different types of latex particles. One kind of latex particles is carboxylated whereas the second kind of latex particles contains oxirane-functional groups. This latex composition provides a number of advantages for the final dip-molded product like achievement of desired mechanical properties without sulfur vulcanization, improved solvent resistance, as required for industrial glove applications and economical production of dip-molded articles in terms of reduction of total process time and reduced energy consumption. Furthermore, the present inventors have discovered that the reaction between the carboxylic acid functional groups on the carboxylated latex with the oxirane-functional groups on the second latex upon crosslinking when forming the dip-molded article results in beta-hydroxy ester linkages that provide for self-healing properties of the resultant elastomeric film as described in the co-pending application PCT/MY2019/000017.

Thus, it is the object of the present invention to provide a polymer latex composition that results in softer films, while maintaining the advantageous properties of the polymer latex described, for example in WO 2017/209596.

Another object is to provide a polymer latex composition that can be more economically produced, while maintaining the advantageous properties of the polymer latex described, for example in WO 2017/209596.

Another object is to provide a polymer latex composition that has increased pot life, while maintaining the advantageous properties of the polymer latex described in, for example WO 2017/209596.

### SUMMARY OF THE INVENTION

Thus, according to one aspect the present invention relates to a polymer latex for the preparation of elastomeric films comprising:
(A) particles of a latex polymer (A) obtainable by free-radical emulsion polymerization of a mixture of ethylenically unsaturated monomers the latex polymer comprising a plurality of functional groups (x); and
(B) a compound bearing a beta-hydroxy ester linkage and at least one additional functional group (y) reactive with the functional groups (x) on latex polymer (A).

According to a further aspect the present invention relates to a method for preparation of a polymer latex comprising
(i) polymerizing in an emulsion polymerization process a mixture of ethylenically unsaturated monomers for latex polymer (A) comprising at least one monomer resulting after polymerization in a functional group (x) to obtain a latex comprising particles of latex polymer (A) bearing a plurality of functional groups (x); and
(ii) adding a compound (B) bearing a beta-hydroxy ester linkage and at least one additional functional group (y) reactive with the functional groups (x) on latex polymer (A).

The present invention further relates to the use of the above defined polymer latex for the production of articles or for coating or impregnating a substrate, preferably a textile substrate.

The present invention further relates to a compounded latex composition suitable for the production of articles comprising the polymer latex as defined above and optionally adjuvants selected from sulfur vulcanization agents, accelerators for sulfur vulcanization, crosslinkers, polyvalent cations and combinations thereof.

As mentioned above, the polymer latex of the present invention can be successfully employed without sulfur vulcanization agents and accelerators for sulfur vulcanization without compromising the required mechanical properties. Thus, it is preferred that the compounded latex composition of the present invention is free of sulfur vulcanization agents and accelerators for sulfur vulcanization.

The present invention further relates to a method for making dip-molded articles by
a) providing a compounded latex according to the present invention;
b) immersing a mold having the desired shape of the final article in a coagulant bath comprising a solution of a metal salt;
c) removing the mold from the coagulant bath and optionally drying the mold;
d) immersing the mold as treated in step b) and c) in the compounded latex composition of step a);
e) coagulating a latex film on the surface of the mold;
f) removing the latex-coated mold from the compounded latex composition and optionally immersing the latex-coated mold in a water bath;
g) optionally drying the latex-coated mold;
h) heat treating the latex-coated mold obtained from step e) or f) at a temperature of 40° C. to 180° C. and/or exposing the latex-coated mold obtained from step e) or f) to UV radiation; and
i) removing the latex article from the mold.

The present invention also relates to an article made by using the polymer latex or the compounded latex composition according to the present invention.

### DETAILED DESCRIPTION OF THE INVENTION

The present invention relates to a polymer latex comprising:
(A) particles of a latex polymer (A) obtainable by free-radical emulsion polymerization of a mixture of ethylenically unsaturated monomers the latex polymer comprising a plurality of functional groups (x); and
(B) a compound bearing a beta-hydroxy ester linkage and at least one additional functional group (y) reactive with the functional groups (x) on latex polymer (A).

Suitable functional groups (x) on the latex polymer (A) may be selected from groups having a carbon-carbon double bond, carboxylic acid functional groups, hydroxyl, epoxy, acetoacetyl, primary or secondary amino, acetoxy, isocyanato, alkoxysilyl, alkoxy, dioxolanone functional groups and combinations thereof.

### Latex Polymer (A) Comprising a Plurality of Functional Groups (x)

The latex polymer (A) to be used according to the present invention can be prepared by any suitable free-radical emulsion polymerization process known in the art. Suitable process parameters are those that will be discussed below.

The unsaturated monomers to be used for the preparation of the latex polymer (A) and their relative amounts are not particularly critical as long as the monomer mixture comprises at least one ethylenically unsaturated monomer that provides for a plurality of functional groups (x) on the latex polymer (A). Monomer compositions comprising conjugated dienes and ethylenically unsaturated nitrile compounds are particularly useful for dip-molding applications.

According to the present invention the monomer composition for the latex polymer (A) may comprise:
(a) 15 to 99 wt.-% of conjugated dienes;
(b) 1 to 80 wt.-% of monomers selected from ethylenically unsaturated nitrile compounds;
(c) 0 to 10 wt.-% of an ethylenically unsaturated compound bearing a functional group (x) different from conjugated dienes,
(d) 0 to 80 wt.-% of vinyl aromatic monomers; and
(e) 0 to 65 wt.-% of alkyl esters of ethylenically unsaturated acids, the weight percentages being based on the total weight of monomers in the monomer mixture.

Conjugated diene monomers suitable for the preparation of latex polymer (A) according to the present invention include conjugated diene monomers, selected from 1,3-butadiene, isoprene, 2,3-dimethyl-1,3-butadiene, 2,3-dimethyl-1,3-butadiene, 2-chloro-1,3-butadiene, 1,3- pentadiene, 1,3-hexadiene, 2,4-hexadiene, 1,3-octadiene, 2-methyl-1,3-pentadiene, 2,3-dimethyl-1,3-pentadiene, 3,4- dimethyl-1,3-hexadiene, 2,3-diethyl-1,3-butadiene, 4,5-diethyl-1,3-octadiene, 3-butyl-1,3-octadiene, 3,7-dimethyl-1,3,6-octatriene, 2-methyl-6-methylene-1,7-octadiene, 7-methyl-3-methylene-1,6-octadiene, 1,3,7-octatriene, 2-ethyl-1,3-butadiene, 2-amyl-1,3-butadiene, 3,7-dimethyl-1,3,7- octatriene, 3,7-dimethyl-1,3,6-octatriene, 3,7,11- trimethyl-1,3,6,10-dodecatetraene, 7,11-dimethyl-3-methylene-1,6,10-dodecatriene, 2,6-dimethyl-2,4,6-octatriene, 2-phenyl-1,3-butadiene and 2-methyl-3-isopropyl-1,3-butadiene and 1,3-cyclohexadiene. 1,3-Butadiene, isoprene and combinations thereof are the preferred conjugated dienes. 1,3-Butadiene is the most preferred diene. Typically, the amount of conjugated diene monomer ranges from 15 to 99 wt.-%, preferably from 20 to 99 wt.-%, more preferred from 30 to 75 wt.-%, most preferred from 40 to 70 wt.-%, based on the total weight of monomers. Thus, the conjugated diene may be present in amounts of at least 15 wt .-%, at least 20 wt.-%, at least 22 wt.-%, at least 24 wt.-%, at least 26 wt.-%, at least 28 wt.-%, at least 30 wt.-%, at least 32 wt.-%, at least 34 wt.-%, at least 36 wt.-%, at least 38 wt.-%, or at least 40 wt.-%, based on the total weight of the ethylenically unsaturated monomers for latex polymer (A).

Accordingly, the conjugated diene monomers can be used in amounts of no more than 95 wt.-%, no more than 90 wt.-%, no more than 85 wt.-%, no more than 80 wt.-%, no more than 78 wt.-%, no more than 76 wt.-%, no more than 74 wt.-%, no more than 72 wt.-%, no more than 70 wt.-%, no more than 68 wt.-%, no more than 66 wt.-%, no more than 64 wt.-%, no more than 62 wt.-%, no more than 60 wt.-%, no more than 58 wt.-%, or no more than 56 wt.-%. A person skilled in the art will appreciate that any range between any of the explicitly disclosed lower and upper limit is herein disclosed.

Unsaturated nitrile monomers which can be used in the present invention include polymerizable unsaturated aliphatic nitrile monomers which contain from 2 to 4 carbon atoms in a linear or branched arrangement, which may be substituted either by acetyl or additional nitrile groups. Such nitrile monomers include acrylonitrile, methacrylonitrile, alpha-cyanoethyl acrylonitrile, fumaronitrile and combinations thereof, with acrylonitrile being most preferred. These nitrile monomers can be included in amounts from 1 to 80 wt.-%, preferably from 10 to 70 wt.-%, or 1 to 60 wt.-%, and more preferred from 15 to 50 wt.-%, even more preferred from 20 to 50 wt.-%, most preferred from 23 to 43 wt.-%, based on the total weight of ethylenically unsaturated monomers for latex polymer (A).

Thus, the unsaturated nitrile may be present in amounts of at least 1 wt.-%, 5 wt.-%, at least 10 wt.-%, at least 12 wt.-%, at least 14 wt.-%, at least 16 wt.-%, at least 18 wt.-%, at least 20 wt.-%, at least 22 wt.-%, at least 24 wt.-%, at least 26 wt.-%, at least 28 wt.-%, at least 30 wt.-%, at least 32 wt.-%, at least 34 wt.-%, at least 36 wt.-%, at least 38 wt.-%, or at least 40 wt.-%, based on the total weight of the ethylenically unsaturated monomers for latex polymer (a).

Accordingly, the unsaturated nitrile monomers can be used in amounts of no more than 80 wt.-%, no more than 75 wt.-%, no more than 73 wt.-%, no more than 70 wt.-%, no more than 68 wt.-%, no more than 66 wt.-%, no more than 64 wt.-%, no more than 62 wt.-%, no more than 60 wt.-%, no more than 58 wt.-%, no more than 56 wt.-%, no more than 54 wt.-%, no more than 52 wt.-%, no more than 50 wt.-%, no more than 48 wt.-%, no more than 46 wt.-%, or no more than 44 wt.-%. A person skilled in the art will appreciate that any range between any of the explicitly disclosed lower and upper limit is herein disclosed.

In the monomer composition for the preparation of latex polymer (A) according to the present invention the ethylenically unsaturated compounds different from conjugated dienes bearing a functional group (x) may selected from
(c1) ethylenically unsaturated compounds having at least two different ethylenically unsaturated groups;
(c2) ethylenically unsaturated acids and salts thereof;
(c3) hydroxy functional ethylenically unsaturated compounds;
(c4) oxirane functional ethylenically unsaturated compounds;
(c5) acetoacetyl functional ethylenically unsaturated compounds;
(c6) ethylically unsaturated compounds bearing a primary or secondary amino group;
(c7) acetoxy functional ethylenically unsaturated compounds;
(c8) isocyanato functional ethylenically unsaturated compounds;
(c9) alkoxysilyl functional ethylenically unsaturated compounds;
(c10) alkoxy functional ethylenically unsaturated compounds;
(c11) dioxolanone functional ethylenically unsaturated compounds; and combinations thereof;

Suitable ethylenically unsaturated compounds (c1) having at least two different ethylenically unsaturated groups may be selected from allyl(meth)acrylate and vinyl(meth)acrylate.

Suitable ethylenically unsaturated acids (c2) and salts thereof may be selected from ethylenically unsaturated carboxylic acid monomers, ethylenically unsaturated sulfonic acid monomers, ethylenically unsaturated phosphorous-containing acid monomers. The ethylenically unsaturated carboxylic acid monomers suitable for use in the present invention include monocarboxylic acid and dicarboxylic acid monomers, monoesters of dicarboxylic acid and carboxy alkyl esters of ethylenically unsaturated acids such as 2-carboxy ethyl (meth)acrylate. Carrying out the present invention, it is preferable to use ethylenically unsaturated aliphatic mono- or dicarboxylic acids or anhydrides which contain from 3 to 5 carbon atoms. Examples of monocarboxylic acid monomers include acrylic acid, methacrylic acid, crotonic acid and examples of dicarboxylic acid monomers include fumaric acid, itaconic acid, maleic acid and maleic anhydride. Examples of other suitable ethylenically unsaturated acids include vinyl acetic acid, vinyl lactic acid, vinyl sulfonic acid, 2-methyl-2-propene-1-sulfonic acid, styrene sulfonic acid, acrylamidomethyl propane sulfonic acid and the salts thereof. (Meth)acrylic acid, crotonic acid, itaconic acid, maleic acid, fumaric acid and combinations thereof are particularly preferred.

Examples of ethylenically unsaturated sulfonic acid monomers: vinylsulfonic acid, phenyl vinylsulfonate, sodium 4-vinylbenzenesulfonate, 2-methyl-2-propene-1-sulfonic acid, 4-styrenesulfonic acid, 3-allyloxy-2-hydroxy-1-propanesulfonic acid, 2-acrylamido-2-methyl-1-propanesulfonic acid and the salts thereof.

Examples of ethylenically unsaturated phosphorus-containing acid monomers: vinylphosphonic acid, dimethyl vinylphosphonate, diethyl vinylphosphonate, diethyl allylphosphonate, allylphosphonic acid and the salts thereof.

Suitable hydroxy functional ethylenically unsaturated compounds (c3) may be selected from N-methylolacrylamide and hydroxyalkyl esters of ethylenically unsaturated acids.

The hydroxy alkyl(meth)acrylate monomers which can be used to prepare the polymer latex according to the present invention include hydroxyalkyl acrylate and methacrylate monomers which are based on ethylene oxide, propylene oxide and higher alkylene oxides or mixtures thereof. Examples are hydroxyethyl acrylate, hydroxypropyl acrylate, hydroxyethyl methacrylate, hydroxypropyl methacrylate and hydroxybutyl acrylate. Preferably, the hydroxy alkyl(meth)acrylate monomer is 2-hydroxy ethyl(meth)acrylate.

Suitable oxirane-functional ethylenically unsaturated monomers (c4) may be selected from glycidyl (meth)acrylate, allyl glycidylether, vinyl glycidylether, vinyl cyclohexene oxide, limonene oxide, 2-ethylglycidylacrylate, 2-ethylglycidylmethacrylate, 2-(n-propyl)glycidylacrylate, 2-(n-propyl)glycidylmethacrylate, 2-(n-butyl)glycidylacrylate, 2-(n-butyl)glycidylmethacrylate, glycidylmethylmethacrylate, glycidylacrylate, (3′,4′-epoxyheptyl)-2-ethylacrylate, (3′,4′-epoxyheptyl)-2-ethylmethacrylate, (6″,7′-epoxyheptyl)acrylate, (6′,7′-epoxyheptyl)methacrylate, allyl-3,4-epoxyheptylether, 6,7-epoxyheptylallylether, vinyl-3,4-epoxyheptylether, 3,4-epoxyheptylvinylether, 6,7-epoxyheptylvinylether, o-vinylbenzylglycidylether, m-vinylbenzylglycidylether, p-vinylbenzylglycidylether, 3-vinyl cyclohexene oxide, alpha-methyl glycidyl methacrylate, 3,4-epoxycyclohexylmethyl (meth)acrylate and combinations thereof. Glycidyl (meth)acrylate is particularly preferred.

Suitable acetoacetyl functional ethylenically unsaturated compounds (c5) may be selected from acetoacetoxyethyl (meth)acrylate, acetoacetoxypropyl (meth)acrylate, allyl acetoacetate, acetoacetoxybutyl (meth)acrylate, 2,3-di(acetoacetoxy)propyl (meth)acrylate, (2-acetoacetamido-2-methylpropyl) (meth)acrylate, 3-(methacryloyloxy)-2,2-dimethylpropyl 3-oxobutanoate, 3-(methacryloyloxy)-2,2,4,4-tetramethylcyclobutyl 3-oxobutanoate, l-((meth)acryloyloxy)-2,2,4-trimethylpentan-3-yl 3-oxobutanoate, (4-((meth)acryloyloxymethyl)cyclohexyl)methyl 3- oxobutanoate.

Suitable ethylenically unsaturated compounds bearing a primary or secondary amino group (c6) may be selected from (meth)acrylamide, alkyl(meth)acrylamides for example N-ethyl(meth)acrylamide, N-tert-butyl(meth)acrylamide, N-phenyl(meth)acrylamide, N-(isobutoxymethyl)(meth)acrylamide, N-propyl(meth)acrylamide, aminoalkyl esters of ethylenically unsaturated acids for example 2-amino ethyl (meth)acrylate, N-(3-aminopropyl) (meth)acrylamide hydrochloride, 2-aminoethyl(meth)acrylamide hydrochloride, (2-(N-tert-butoxycarbonylamino)ethyl(meth)acrylate, and N-3-(Dimethylamino)propyl(meth)acrylamide.

Suitable acetoxy functional ethylenically unsaturated compounds (c7) may be selected from diacetoneacrylamide.

Suitable isocyanato functional ethylenically unsaturated compounds (c8) may be selected from 2-isocyanate ethyl (meth)acrylate, allyl isocyanate, vinyl isocyanate, 3-isopropenyl-α,α-dimethylbenzyl isocyanate.

Suitable alkoxysilyl functional ethylenically unsaturated compounds (c9) may be selected from vinyl trimethoxy silane, vinyl triethoxy silane and 3-methacryloxypropyltrimethoxysilane;

Suitable alkoxy functional ethylenically unsaturated compounds (c10) may be selected from N-methoxymethyl-(meth)acrylamide, N-n-butoxy-methyl-(meth)acrylamide, N-iso-butoxy-methyl-(meth)acrylamide, 2-methoxy ethyl (meth)acrylate, 2- ethoxyethyl (meth)acrylate, 2-butoxyethyl (meth)acrylate, and methoxyethoxyethyl acrylate. Preferred alkoxy functional ethylenically unsaturated compounds are ethoxyethyl acrylate and methoxyethyl acrylate.

Suitable dioxolanone functional ethylenically unsaturated compounds (c11) may be selected from glycerol carbonate (meth)acrylate and 4-Vinyl-1,3-dioxolan-2-one (vinyl ethylene carbonate.

Monomers c) provide functional groups (x) that are reactive with the functional groups (y) on compound (B) according to the present invention. In addition, due to their polarity they may influence the properties of the polymer dispersion. The type and the amount of these monomers are determined thereby. Typically, such an amount is from 0.05 to 10 wt.-%, particularly from 0.1 to 10 wt.-% or 0.5 to 7 wt.-%, preferably from 0.1 to 9 wt.-%, more preferred from 0.1 to 8 wt.-%, even more preferred from 1 to 7 wt.-%, most preferred 2 to 7 wt.-%, based on the total weight of the ethylenically unsaturated monomers for latex polymer (a). Thus, the ethylenically unsaturated acid compounds (c) may be present in amounts of at least 0.01 wt.-%, at least 0.05 wt.-%, at least 0.1 wt.-%, at least 0.3 wt.-%, at least 0.5 wt.-%, at least 0.7 wt.-%, at least 0.9 wt.-%, at least 1 wt.-%, at least 1.2 wt.-%, at least 1.4 wt.-%, at least 1.6 wt.-%, at least 1.8 wt.-%, at least 2 wt.-%, at least 2.5 wt.-%, or at least 3 wt.-%. Likewise, the ethylenically unsaturated compounds (c) may be present in amounts of no more than 10 wt.-%, no more than 9.5 wt.-%, no more than 9 wt.-%, no more than 8.5 wt.-%, no more than 8 wt.-%, no more than 7.5 wt.-%, no more than 7 wt.-%, no more than 6.5 wt.-%, no more than 6 wt.-%, no more than 5.5 wt.-%, or no more than 5 wt.-%, based on the total weight of ethylenically unsaturated monomers for latex polymer (A). A person skilled in the art will appreciate that any range defined by an explicitly disclosed lower limit and an explicitly disclosed upper limit is disclosed herewith.

Representatives of vinyl-aromatic monomers include, for example, styrene, α-methylstyrene, vinyltoluene, o-methylstyrene, p- methylstyrene, p-tert-butylstyrene, 2,4-dimethylstyrene, 2-methylstyrene, 3-methylstyrene, 4-methylstyrene, 2-ethylstyrene, 3-ethylstyrene, 4-ethylstyrene, 2,4-diisopropylstyrene, 2,4-dimethylstyrene, 4-t-butylstyrene, 5-t-butyl-2-methylstyrene, 2- chlorostyrene, 3-chlorostyrene, 4 -chlorostyrene, 4-bromostyrene, 2-methyl-4,6-dichlorostyrene, 2,4-dibromostyrene, vinylnaphthalene, vinyltoluene and vinylxylene, 2-vinylpyridine, 4-vinylpyridine and 1,1- diphenylethylenes and substituted 1,1-diphenylethylenes, 1,2-diphenylethene and substituted 1,2-diphenylethylenes. Mixtures of one or more of the vinyl-aromatic compounds may also be used. The preferred monomers are styrene and α-methylstyrene. The vinyl-aromatic compounds can be used in a range of from 0 to 80 wt.-%, or 0 - 70 wt.-%, or 0 to 50 wt.-%, preferably from 0 to 40 wt.-% more preferred from 0 to 25 wt.-%, even more preferred from 0 to 15 wt.-%, and most preferred from 0 to 10 wt.-%, based on the total weight of ethylenically unsaturated monomers for latex polymer (A). Thus, the vinyl-aromatic compound can be present in an amount of no more than 80 wt.-%, no more than 75 wt.-%, no more than 60 wt..-%, no more than 50 wt.-%, no more than 40 wt.-%, 35 wt.-%, no more than 30 wt.-%, no more than 25wt.-%, no more than 20 wt.-%, no more than 18 wt.-%, no more than 16 wt.-%, no more than 14 wt.-%, no more than 12 wt.-%, no more than 10 wt.-%, no more than 8 wt.-%, no more than 6 wt.-%, no more than 4 wt.-%, no more than 2 wt.-%, or no more than 1 wt.-%, based on the total weight of ethylenically unsaturated monomers for latex polymer (A). Vinyl-aromatic compounds may also be completely absent.

Suitable alkyl ester of ethylenically unsaturated acids to be used according the present invention include n-alkyl esters, iso-alkyl esters or tert-alkyl esters of (meth)acrylic acid in which the alkyl group has from 1 to 20 carbon atoms and the reaction product of methacrylic acid with glycidyl ester of a neoacid such as versatic acid, neodecanoic acid or pivalic acid.

In general, the preferred alkyl esters of (meth)acrylic acids may be selected from C₁-C₁₀ alkyl (meth)acrylate, preferably C₁-C₈-alkyl (meth)acrylates. Examples of such acrylate monomers include n-butyl acrylate, secondary butyl acrylate, ethyl acrylate, hexyl acrylate, tert-butyl acrylate, 2-ethyl-hexyl acrylate, isooctyl acrylate, 4-methyl-2-pentyl acrylate, 2-methylbutyl acrylate, methyl methacrylate, butyl methacrylate, n-butyl methacrylate, isobutyl methacrylate, ethyl methacrylate, isopropyl methacrylate, hexyl methacrylate, cyclohexyl methacrylate and cetyl methacrylate. Methyl (meth)acrylate, ethyl (meth)acrylate, propyl (meth)acrylate, butyl (meth)acrylate, 2-ethylhexyl (meth)acrylate and combinations thereof are preferred.

Typically, the alkyl esters of ethylenically unsaturated acids can be present in an amount of no more than 65 wt.-%, no more than 60 wt.-%, no more than 55 wt.-%, no more than 50 wt.-%, no more than 45wt.-%, no more than 40 wt.-%, no more than 35 wt.-%, no more than 30 wt.-%, no more than 25 wt.-%, no more than 20 wt.-%, no more than 18 wt.-%, no more than 16 wt.-%, no more than 14 wt.-%, no more than 12 wt.-%, no more than 10 wt.-%, no more than 8 wt.-%, no more than 6 wt.-%, no more than 4 wt.-%, no more than 2 wt.-%, or no more than 1 wt.-%, based on the total weight of ethylenically unsaturated monomers for latex polymer (A).

Further, the mixture of ethylenically unsaturated monomers for latex polymer (A) according to the present invention may include additional ethylenically unsaturated monomers that are different from the above-defined monomers. These monomers may be selected from vinyl esters and monomer having two identical ethylenically unsaturated groups.

Vinyl ester monomers which can be used according to the present invention include vinyl acetate, vinyl proprionate, vinyl butyrate, vinyl benzoate, vinyl-2-ethylhexanoate, vinyl stearate, and the vinyl esters of versatic acid. The most preferred vinyl ester monomer for use in the present invention is vinyl acetate. Typically, the vinyl ester monomers can be present in an amount of no more than 18 wt.-%, no more than 16 wt.-%, no more than 14 wt.-%, no more than 12 wt.-%, no more than 10 wt.-%, no more than 8 wt.-%, no more than 6 wt.-%, no more than 4 wt.-%, no more than 2 wt.-%, or no more than 1 wt.-%, based on the total weight of ethylenically unsaturated monomers for latex polymer (a).

Furthermore, monomers having at least two identical ethylenically unsaturated groups can be present in the monomer mixture for the preparation of the polymer latex of the present invention in an amount 0 to 6.0 wt.-%, preferably 0.1 to 3.5 wt.-%, based on the total weight of ethylenically unsaturated monomers. Typically, these monomers can be present in an amount of no more than 6 wt.-%, no more than 4 wt.-%, no more than 2 wt.-%, no more than 1 wt.-%, based on the total weight of ethylenically unsaturated monomers. Suitable bifunctional monomers which are capable of providing internal crosslinking and branching in the polymer (herein known as multifunctional monomers) may be selected from divinyl benzene and diacrylates and di(meth)acrylates. Examples are ethylene glycol di(meth)acrylate, hexanediol di(meth)acrylate, tripropylene glycol di(meth)acrylate, butanediol di(meth)acrylate, neopentyl glycol di(meth)acrylate, diethylene glycol di(meth)acrylate, triethylene glycol di(meth)acrylate, and dipropylene glycol di(meth)acrylate. The monomers having at least two ethylenically unsaturated groups are preferably selected from divinyl benzene, 1,2 ethyleneglycol di(meth)acrylate, 1,4-butanediol di(meth)acrylate and 1,6-hexanediol di(meth)acrylate.

According to the present invention, the amounts of the above-defined monomers for the preparation of latex polymer (A) may add up to 100 wt.-%.

The mixture of the ethylenically unsaturated monomers for latex polymer (A) may comprise from:
20 to 99 wt.-% of conjugated dienes, preferably selected from butadiene, isoprene and combinations thereof, more preferred butadiene;
1 to 60 wt.-% of monomers selected from ethylenically unsaturated nitrile compounds, preferably acrylonitrile;
0 to 70 wt.-% of vinyl aromatic monomers, preferably styrene;
0 to 25 wt.-% of C₁ to C₈ alkyl (meth)acrylates;
0.05 to 7 wt.-% of ethylenically unsaturated acids, preferably (meth)acrylic acid;
0 to 10 wt.-% of vinyl esters:
the weight percentages being based on the total monomers present in the mixture.

### Method for the Preparation of the Polymer Latex of the Present Invention

The latex polymer (A) according to the present invention can be made by any emulsion polymerization process known to a person skilled in the art, provided that the monomer mixture as herein defined is employed. Particularly suitable is the process as described in EP-A 792 891.

In the emulsion polymerization for preparing the latex polymer (A) of the present invention a seed latex may be employed. Any seed particles as known to the person skilled in the art can be used.

The seed latex particles are preferably present in an amount of 0.01 to 10, preferably 1 to 5 parts by weight, based on 100 parts by weight of total ethylenically unsaturated monomers employed in the polymer latex including those for making the seed particles, such as the oxirane-functional latex particles (b). The lower limit of the amount of seed latex particles therefore can be 0.01, 0.05, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, or 2.5 parts by weight. The upper limit of the amount can be 10, 9, 8, 7, 6, 5.5, 5, 4.5, 4, 3.8, 3.6, 3.4, 3.3, 3.2, 3.1 or 3 parts by weight. A person skilled in the art will understand that any range formed by any of the explicitly disclosed lower limits and upper limits is explicitly encompassed in the present specification.

The process for the preparation of the above-described polymer latex can be performed at temperatures of from 0 to 130° C., preferably of from 0 to 100° C., particularly preferably of from 5 to 70° C., very particularly preferably of from 5 to 60° C., in the presence of no or one or more emulsifiers, no or one or more colloids and one or more initiators. The temperature includes all values and sub-values therebetween, especially including 5, 10, 15, 20, 25, 30, 35, 40, 45, 50, 55, 60, 65, 70, 75, 80, 85, 90, 95, 100, 105, 110, 115, 120 and 125° C.

Initiators which can be used when carrying out the present invention include watersoluble and/or oil-soluble initiators which are effective for the purposes of the polymerization. Representative initiators are well known in the technical area and include, for example: azo compounds (such as, for example, AIBN, AMBN and cyanovaleric acid) and inorganic peroxy compounds, such as hydrogen peroxide, sodium, potassium and ammonium peroxydisulfate, peroxycarbonates and peroxyborates, as well as organic peroxy compounds, such as alkyl hydroperoxides, dialkyl peroxides, acyl hydroperoxides, and diacyl peroxides, as well as esters, such as tertiary butyl perbenzoate and combinations of inorganic and organic initiators.

The initiator is used in a sufficient amount to initiate the polymerization reaction at a desired rate. In general, an amount of initiator of from 0.01 to 5, preferably of from 0.1 to 4 %, by weight, based on the weight of the total polymer, is sufficient. The amount of initiator is most preferably of from 0.01 to 2% by weight, based on the total weight of the polymer. The amount of initiator includes all values and sub-values therebetween, especially including 0.01, 0.1, 0.5, 1, 1.5, 2, 2.5, 3, 4 and 4.5 % by weight, based on the total weight of the polymer.

The above-mentioned inorganic and organic peroxy compounds may also be used alone or in combination with one or more suitable reducing agents, as is well known in the art. Examples of such reducing agents which may be mentioned are sulfur dioxide, alkali metal disulfites, alkali metal and ammonium hydrogen sulfites, thiosulfates, dithionites and formaldehyde sulfoxylates, as well as hydroxylamine hydrochloride, hydrazine sulfate, iron (II) sulfate, cuprous naphthanate, glucose, sulfonic acid compounds such as sodium methane sulfonate, amine compounds such as dimethylaniline and ascorbic acid. The quantity of the reducing agent is preferably 0.03 to 10 parts by weight per part by weight of the polymerization initiator.

Surfactants or emulsifiers which are suitable for stabilizing the latex particles include those conventional surface-active agents for polymerization processes. The surfactant or surfactants can be added to the aqueous phase and/or the monomer phase. An effective amount of surfactant in a seed process is the amount which was chosen for supporting the stabilization of the particle as a colloid, the minimization of contact between the particles and the prevention of coagulation. In a non-seeded process, an effective amount of surfactant is the amount which was chosen for influencing the particle size.

Representative surfactants include saturated and ethylenically unsaturated sulfonic acids or salts thereof, including, for example, unsaturated hydrocarbonsulfonic acid, such as vinylsulfonic acid, allylsulfonic acid and methallylsulfonic acid, and salts thereof; aromatic hydrocarbon acids, such as, for example, p-styrenesulfonic acid, isopropenylbenzenesulfonic acid and vinyloxybenzenesulfonic acid and salts thereof; sulfoalkyl esters of acrylic acid and methacrylic acid, such as, for example, sulfoethyl methacrylate and sulfopropyl methacrylate and salts thereof, and 2-acrylamido-2-methylpropanesulfonic acid and salts thereof; alkylated diphenyl oxide disulfonates, sodium dodecylbenzenesulfonates and dihexyl esters of sodium sulfosuccinate, Sodium alkyl esters of sulfonic acid, ethoxylated alkylphenols and ethoxylated alcohols; fatty alcohol (poly)ethersulfates.

The type and the amount of the surfactant is governed typically by the number of particles, their size and their composition. Typically, the surfactant is used in amounts of from 0 to 20, preferably from 0 to 10, more preferably from 0 to 5, wt.-%, based on the total weight of the monomers. The amount of surfactant includes all values and sub-values there between, especially including 0, 0.1, 0.5, 1, 2, 3, 4, 5, 6, 7, 8, 9, 10, 11, 12, 13, 14, 15, 16, 17, 18 and 19 wt.-%, based on the total weight of the monomer. According to one embodiment of the present invention, the polymerization is conducted without using surfactants.

Various protective colloids can also be used instead of or in addition to the surfactants described above. Suitable colloids include polyhydroxy compounds, such as partially acetylated polyvinyl alcohol, casein, hydroxyethyl starch, carboxymethylcellulose, hydroxyethylcellulose, hydroxypropylcellulose, polysaccharides, and degraded polysaccharides, polyethylene glycol and gum arabic. The preferred protective colloids are carboxymethylcellulose, hydroxyethylcellulose and hydroxypropylcellulose. In general, these protective colloids are used in contents of from 0 to 10, preferably from 0 to 5, more preferably from 0 to 2 parts by weight, based on the total weight of the monomers. The amount of protective colloids includes all values and sub-values therebetween, especially including 1, 2, 3, 4, 5, 6, 7, 8 and 9 wt.-%, based on the total weight of the monomers.

The person skilled in the art will appreciate the type and amounts of monomers bearing polar functional groups, surfactants and protective colloids that are to be selected to make the polymer latex according to the present invention suitable for dip-molding applications. Thus, it is preferred that the polymer latex composition of the present invention has a certain maximum electrolyte stability determined as critical coagulation concentration of less than 30 mmol/l CaCl₂, preferably less than 25 mmol/l, more preferred less than 20 mmol/l, most preferred less than 10 mmol/l (determined for a total solids content of the composition of 0.1% at pH 10 and 23° C.).

If the electrolyte stability is too high, then it will be difficult to coagulate the polymer latex in a dip-molding process, with the result that either no continuous film of the polymer latex on the immersed mold is formed or the thickness of the resulting product is nonuniform.

It is within the routine of the person skilled in the art to appropriately adjust the electrolyte stability of a polymer latex. The electrolyte stability will depend on certain different factors, for example, amount and selection of monomers to be used for making the polymer latex, especially monomers containing polar-functional groups, as well as the selection and amount of the stabilizing system, for example, the emulsion polymerization process for making the polymer latex. The stabilizing system may contain surface-active agents and/or protective colloids.

A person skilled in the art is able, depending on the selected monomers and their relative amounts for making the polymer latex of the present invention, to adjust the stabilizing system in order to achieve an electrolyte stability according to the present invention.

Since there are so many different influences on the electrolyte stability, the adjustment is best made by trial and error experiments. But this can be easily done without any inappropriate effort using the test method for electrolyte stability, as disclosed above.

It is frequently advisable to perform the emulsion polymerization additionally in the presence of buffer substances and chelating agents. Suitable substances are, for example, alkali metal phosphates and pyrophosphates (buffer substances) and the alkali metal salts of ethylenediaminetetraacetic acid (EDTA) or hydroxyl-2-ethylenediaminetriacetic acid (HEEDTA) as chelating agents. The quantity of buffer substances and chelating agents is usually 0.001-1.0 wt.-%, based on the total quantity of monomers.

Furthermore, it may be advantageous to use chain transfer agents (regulators) in emulsion polymerization. Typical agents are, for example, organic sulfur compounds, such as thioesters, 2-mercaptoethanol, 3-mercaptopropionic acid and C₁-C₁₂ alkyl mercaptans, n-dodecylmercaptan and t-dodecylmercaptan being preferred. The quantity of chain transfer agents, if present, is usually 0.05-3.0 wt.-%, preferably 0.2-2.0 wt.-%, based on the total weight of the used monomers.

Furthermore, it can be beneficial to introduce partial neutralization to the polymerization process. A person skilled in the art will appreciate that by appropriate selections of this parameter the necessary control can be achieved.

Various other additives and ingredients can be added in order to prepare the latex composition of the present invention. Such additives include, for example: antifoams, wetting agents, thickeners, plasticizers, fillers, pigments, dispersants, optical brighteners, crosslinking agents, accelerators, antioxidants, biocides and metal chelating agents. Known antifoams include silicone oils and acetylene glycols. Customary known wetting agents include alkylphenol ethoxylates, alkali metal dialkylsulfosuccinates, acetylene glycols and alkali metal alkylsulfate. Typical thickeners include polyacrylates, polyacrylamides, xanthan gums, modified celluloses or particulate thickeners, such as silicas and clays. Typical plasticizers include mineral oil, liquid polybutenes, liquid polyacrylates and lanolin. Zinc oxide is a suitable crosslinking agent. Titanium dioxide (TiO₂), calcium carbonate and clay are the fillers typically used. Known accelerators and secondary accelerators include dithiocarbamates like zinc diethyl dithiocarbamate, zincdibutyl dithiocarbamate, zinc dibenyl dithiocarbamate, zinc pentamethylene dithiocarbamate (ZPD), xanthates, thiurams like tetramethylthiuram monosulfide (TMTM), Tetramethylthiuram disulfide (TMTD), tetraethylthiuram disulfide (TETD), dipentamethylenethiuram hexasulfide (DPTT), and amines, such as diphenylguanidine (DPG), di-o-tolylguanidine (DOTG), o-tolylbiguanidine (OTBG).

### Compound (B)

According to the present invention any compound can be used that comprises a beta-hydroxy ester linkage and at least one additional functional group (y) that is reactive with the functional groups (x) on the latex polymer (A). Depending on the type of functional groups (x) on the latex polymer (A) the functional group (y) may be selected from carbon-carbon double bonds, epoxy, thiol, hydroxy, primary or secondary amino, isocyanato, oxazolino, aziridino, imino, carbodiimido, glycol groups, ester groups, acetoxy, carboxylic acid groups, alkoxy silyl groups, dioxolanone groups, hydrazido, and combinations thereof.

The functional group (y) provides for crosslinking capability with the functional groups (x) on the latex polymer (A) to ensure that the elastomeric film of the final dip-molded article exhibits the desired mechanical properties even if no sulfur vulcanization is used. It is preferred that compound (B) comprises a plurality for example two or three, preferably two functional groups (y). But it is sufficient that compound (B) comprise one functional group (x) since the beta- hydroxy ester linkage is also capable of reacting with functional groups on the latex polymer chains such as hydroxy groups or alkoxy groups in a trans-esterification reaction to provide for cross-linking. It is particularly suitable but not necessary that the functional group(s) (y) is (are) in a terminal position in compound (B).

The beta hydroxy ester linkage can be reversibly opened and reformed and thus provides for the self healing properties and recyclability of an elastomeric films formed from the polymer latex of the present invention as has been shown in the co-pending application PCT/MY2019/000017. This is also the case if compound (B) has only one functional group (y) and the beta hydroxy ester linkage participates in a cross-linking reaction via trans-esterification. Then, still in the finally crosslinked film a thermally labile beta hydroxy ester linkage is present.

Functional groups (x) on the latex polymer (A) and functional groups (y) on compound (B) may be selected to provide following combinations:
the functional groups (x) are selected from groups having a carbon-carbon double bond and the functional groups (y) are selected from groups having carbon-carbon double bonds and thiol; or
the functional groups (x) are selected from carboxylic acid functional groups and the functional groups (y) are selected from epoxy, thiol, hydroxy, primary or secondary amino, isocyanato, oxazolino, aziridino, imino, carbodiimido, glycol groups, ester groups, and acetoxy; or
the functional groups (x) are selected from hydroxyl and the functional groups (y) are selected from alkoxysilyl, carboxylic acid functional groups; isocyanato, primary or secondary amino, and ester groups; or
the functional groups (x) are selected from epoxy and the functional groups (y) are selected from carboxylic acid functional groups, hydroxyl and ester groups; or
the functional groups (x) are selected from acetoacetyl and the functional groups (y) are selected from groups having carbon-carbon double bonds, isocyanato and primary or secondary amino; or
the functional groups (x) are selected from primary or secondary amino and the functional groups (y) are selected from carboxylic acid functional groups, epoxy, ester groups and dioxolanone groups; or
the functional groups (x) are selected from acetoxy and the functional groups (y) are selected from hydrazido and primary or secondary amino; or
the functional groups (x) are selected from isocyanato and the functional groups (y) are selected from carboxylic acid functional groups. hydroxyl, primary or secondary amino and thiol; or
the functional groups (x) are selected from alkoxysilyl and the functional groups (y) are selected hydroxyl and alkoxysilyl; or
the functional groups (x) are selected from alkoxy and the functional groups (y) are selected from ester groups; or
the functional groups (x) are selected from ester groups and the functional groups (y) are selected from hydroxyl, carboxylic acid groups and ester groups; or
the functional groups (x) are selected from dioxolanone groups and the functional groups (y) are selected from primary or secondary amino.

Preferably, compound (B) is selected from glycerol dimethacrylate (GDMA), glycerol 1,3-diglycerolate diacrylate (GDGDA), 3-(acryloyloxy)-2-hydroxypropyl methacrylate, bisphenol A glycerolate diacrylate, levulinic acid methacrylate (KEMA), glyceryl monomethacrylate, fatty acid modified glycidyl methacrylate Bisphenol A glycerolate diacrylate, 2-hydroxy-3-phenoxypropyl (metha) acrylate, eugenyl-2-hydroxypropyl methacrylate and combinations thereof.

The polymer latex of the present invention may comprise 80 to 99.9 wt.-%, preferably 85 to 99.9 wt.-%, more preferred 90 to 99.5 wt.-%, even more preferred 92 to 99.5 wt.-% and most preferred 95 to 99.2 wt.-% of the particles of latex polymer (A) and 0.1 to 20 wt.-%, preferably 0.1 to 15 wt.-%, more preferred 0.5 to 10 wt.-%, even more preferred 0.5 to 8 wt.-% and most preferred 0.8 to 5 wt.-% of compound (B) based on the total weight of latex polymer (A) and compound (B). Thus, the lower limit for the amount of particles of latex polymer (a) may be 80 wt.-%, or 82 wt.-%, or 84 wt.-%, or 86 wt.-%, or 88 wt.-%, or 90 wt.-%, based on the total weight of latex particles in the composition. The upper limit for the amount of particles of latex polymer (a) may be 99.9 wt.-%, or 99.5 wt.-%, or 99 wt.-%, or 98 wt.-%, or 97 wt.-%, or 96 wt.-%, or 95 wt.-%, or 94 wt.-%, or 93 wt.-%, or 92 wt.-%, based on the total weight of latex polymer (A) and compound (B). The lower limit for the amount of compound (B) may be 0.1 wt.-%, or 0.2 wt.-%, or 0.3 wt.-%, or 0.4 wt.-%, or 0.5 wt.-% or 0.6 wt.-%, or 0,8 wt.-%, or 1 wt.-%, or 1.5 wt.-%, or 2 wt.-%, or 2.5 wt.-%, or 3 wt.-%, based on the total weight of latex particles in the composition. The upper limit for the amount of compound (B) may be 20 wt.-%, or 18 wt.-%, or 16 wt.-%, or 14 wt.-%, or 12 wt.-%, or 10 wt.-%, or 9 wt.-%, or 8 wt.-% or 5 wt.-%, based on the total weight of latex polymer (A) and compound (B). A person skilled in the art will understand that any range formed by any of the explicitly disclosed lower limits and upper limits is explicitly disclosed in the present specification.

According to the present invention latex polymer (A) is prepared by aqueous emulsion polymerization as described above. To the obtained polymer latex comprising particles of latex polymer (A) compound (B) is added at any suitable stage prior to forming for example an article comprising an elastomeric film from the polymer latex of the present invention. For example, compound (B) may be added to the polymer latex comprising latex polymer (A) prior or after compounding to a dip-molding composition. It is also possible if compound (B) is inert to the conditions of emulsion polymerization for making latex polymer (A) to polymerize the monomer mixture for latex polymer (A) in presence of compound (B). Compared to WO 2017/209596 the present invention has the economic advantage, that only one type of latex needs to be produced and many suitable compounds (B) are commercially available and can be added to the composition in any convenient way.

### Compounded Latex Composition for the Production of Dip-Molded Articles

The polymer latex of the present invention is particularly suitable for dip-molding processes. Therefore, according to one aspect of the present invention the polymer latex is compounded to produce a curable polymer latex compound composition that can be directly used in dip-molding processes. To get reproducible good physical film properties, it is advisable to adjust the pH of the compounded polymer latex composition by pH modifiers to be in the range of pH 7 to 11, preferably 8 to 10, more preferred 9 to 10, for dipping to produce thin disposable gloves. For producing unsupported and/or supported reusable gloves, it is advisable to adjust the pH of the compounded polymer latex composition by pH modifiers to be in the range of pH 8 to 10, preferably 8.5 to 9.5. The compounded polymer latex composition contains the polymer latex of the present invention, optionally the pH modifiers, preferably ammonia or alkali hydroxides and optionally usual additives to be used in these compositions selected from antioxidants, pigments, TiO₂, fillers and dispersing agents.

Alternatively, instead of compounding the polymer latex of the present invention also a polymer latex comprising the latex polymer (A) as defined above may be compounded in the same way as described above and during or after the compounding step compound (B) as defined above is added to provide the compounded latex composition of the present invention. Of course, all variations with respect to the latex polymer (A), compound (B) and their relative amounts as described above can be used.

It is possible to add conventional vulcanization systems to the compounded polymer latex composition according to the present invention to be used in dip-molding processes, such as sulfur in combination with accelerators, such as thiurams and carbamates and zinc oxide to make it curable. Alternatively, or additionally, a crosslinker component like, for example, polyvalent cations or other polyfunctional organic compounds suitable to react with functional groups on the latex particles in order to achieve chemical crosslinking may be added. But it is a particular advantage of the present invention that sulfur vulcanization systems and cross-linkers may be totally avoided, and the polymer latex compound of the present invention is still curable to provide dip-molded articles having the required tensile properties. It is preferred to use polyvalent cations for example ZnO as additional crosslinker component to appropriately adjust the mechanical properties in particular of very thin elastomeric films having a film thickness of 0.1 mm at most, preferably of 0.01 to 0.1 mm, more preferred 0.03 to 0.08 mm.

In certain heavy duty applications like industrial gloves it might be advantageous to employ, in addition to the self-crosslinking properties of the polymer latex of the present invention, conventional sulfur vulcanization systems as described above in order to further increase the mechanical strength of the dip-molded articles.

### Method for Making Dip-Molded Articles

In a suitable method for making dip-molded latex articles, first, a mold having the desired shape of the final article is immersed in a coagulant bath comprising a solution of a metal salt. The coagulant is usually used as a solution in water, an alcohol or a mixture thereof. As specific examples of the coagulant the metal salts can be metal halides like calcium chloride, magnesium chloride, barium chloride, zinc chloride and aluminum chloride; metal nitrates such as calcium nitrate, barium nitrate and zinc nitrate; metal sulfates like calcium sulfate, magnesium sulfate, and aluminum sulfate; and acetic acid salts such as calcium acetate, barium acetate and zinc acetate. Most preferred are calcium chloride and calcium nitrate. The coagulant solution might contain additives to improve the wetting behavior of the former.

Thereafter, the mold is removed from the bath and optionally dried. The such treated mold is then immersed in the compounded latex composition according to the present invention. Thereby, a thin film of latex is coagulated on the surface of the mold. Alternatively, it is also possible to obtain the latex film by a plurality of dipping steps, particularly two dipping steps in sequence.

Thereafter, the mold is removed from the latex composition and optionally immersed in a water bath in order to extract, for example, polar components from the composition and to wash the coagulated latex film.

Thereafter, the latex coated mold is optionally dried at temperature below 80° C.

Finally, the latex coated mold is heat-treated at a temperature of 40-180° C. and/or exposed to UV radiation in order to obtain the desired mechanical properties for the final film product. Then, the final latex film is removed from the mold. The duration of the heat treatment will depend on the temperature and is typically between 1 and 60 minutes. The higher the temperature, the shorter is the required treatment time.

The inventors of the present invention surprisingly discovered that the dip-molding process can be run more economically when employing the polymer latex of the present invention. Particularly, it was discovered that the duration between forming the compounded latex composition according to the present invention and performing the dip-molding step (maturation time) can be considerably reduced to 180 min or less, compared to compounds made from standard latices that need a maturing time of well above 180 min.

Additionally, the inventors found that the temperature in the heat treatment step can be considerably reduced to be within a range of 40° C. to less than 120° C. without compromising the mechanical properties of the final dip-molded product. Conventional latices require temperature of 120° C. and above to achieve the desired mechanical properties. Thus, when employing the polymer latex of the present invention, the dip-molding process is less time-consuming and less energy-consuming, making it more economical.

According to the present invention, it is therefore preferred that
in the compounding step (a)
   (i) the polymer latex according to the present invention is compounded by adjusting the pH to a range of 7 to 12, preferably 7.5 to 11, more preferred 8 to 10 and by optionally adding ZnO; or
   (ii) a polymer latex comprising the particles of the latex polymer (a) as defined above is compounded by adjusting the pH to a range of 7 to 12, preferably 7.5 to 11, more preferred 8 to 10, and by optionally adding ZnO and by subsequently adding preformed particles of latex polymer (b) as defined above; or
   (iii) a polymer latex comprising the particles of polymer (b) as defined above is compounded by adjusting pH to a range of 7 to 12, preferably 7.5 to 11, more preferred 8 to 10, and optionally adding ZnO and by subsequently adding preformed particles of latex polymer (a) as defined above; and the thereby obtained compounded latex composition being free of sulfur vulcanization agents and sulfur vulcanization accelerators is matured for less than 180 min, preferably 10 min to 150 min, more preferred 20 min to 120 min, most preferred 30 min to 90 min prior to be employed in the immersing step d); and/or
in heat treating step h) the latex-coated mold is heat-treated at a temperature of 40° C. to less than 120° C., preferably 60° C. to 100° C., more preferred 70° C. to 90° C.

The final heat-treated or UV cured polymer latex film has a tensile strength of at least about 7 MPa and an elongation at break of at least about 300%, preferably a tensile strength of at least about 10 MPa, an elongation at break of at least about 350%, more preferred a tensile strength of at least about 15 MPa and an elongation at break of at least about 400% and even more preferred a tensile strength of at least about 20 MPa and an elongation at break of at least about 500%. These mechanical properties were measured according to ASTM D412.

This process can be used for any latex article that can be produced by a dip-molding process known in the art.

As an alternative a cut and seal process may be used. In a first step continuous elastomeric films of the polymer latex are made for example by a casting process and optional curing by heating and/or UV curing. In a next stage two separate continuous elastomeric films are aligned and there is then cutting/stamping of the aligned continuous elastomeric films into a preselected shape to obtain two superposed layers of the elastomeric films in the preselected shape. The superposed layers of elastomeric film are joined together at at least a preselected part of the periphery of the superposed layers to form an elastomeric article. The joining together may be performed by using thermal means, preferably selected from heat sealing and welding or by gluing or a combination of heating and gluing.

The present invention is especially applicable for latex articles selected from health care devices, like surgical gloves, examination gloves, condoms, catheters, balloons and tubing or all different kinds of industrial and household gloves.

Furthermore, the polymer latex of the present invention can also be used for the coating and impregnation of substrates, preferably textile substrates. Suitable products obtained thereby are textile-supported gloves.

The present invention will be further illustrated with reference to the following examples.

### EXAMPLES

### Determination of Physical Parameters

The dispersions were characterized by determination of total solids content (TSC), pH value, gel content, viscosity (Brookfield LVT) and z-average particle size. Furthermore, the final films were tested for tensile properties.

### Determination of Total Solid Contents (TSC)

The determination of total solids content is based on a gravimetric method. 1 - 2 g of the dispersion was weighed into a tared aluminium dish, on an Analytical balance. The dish was stored for 1 hour at 120° C. in a circulating air oven until constant mass was reached. After cooling to room temperature, the final weight was then re-determined. The solids content was calculated as follows:

$$\text{TSC =} \frac{{\text{m}}_{\text{initial}} - {\text{m}}_{\text{final}}}{{\text{m}}_{\text{initial}}} 100 \% \qquad \text{(1)}$$

$$\begin{matrix}{\text{where, m}}_{\text{inital}} = \text{initial mass of latex,} \\ {\text{m}}_{\text{final}} = \text{mass after drying}\end{matrix}$$

### Determination of pH Value

The pH value was determined according to DIN ISO 976. After applying a 2-point calibration using buffer solutions, the electrode of a Schott CG 840 pH meter was immersed in the dispersion at 23° C. and the constant value on the display was recorded as the pH value.

### Determination of Gel Content

A sample of the latex under test was sieved through white filter cloth to remove any skin or coagulum. A thin film of latex was then cast onto a glass plate and spread using an applicator until a film thickness of approximately 0.1~0.3 mm was achieved.

The glass plate was placed in the air-circulating oven at a temperature of 55~60° C. for 2 hours. After drying, the polymer was removed from the plate and cut into small pieces. Approximately 1 gram of the dry polymer was weighed into a 175 ml glass jar and the polymer weight was recorded. 100 ml (± 1 ml) of MEK (methyl ethyl ketone) and a magnetic stirrer bar were then added. The jar was sealed with a lid and placed in the water bath, on the magnetic stirrer which was set to 35° C. Agitation was carried out for 16 hours. After which, the sample was removed from the water bath and allowed to cool to ambient temperature. A shallow foil cup was accurately weighed. The jar was set aside for a while to separate the solvent and un-dissolved polymer. 15 ml of the solution was filtered through a filter paper into a clear glass container before 5 mL of this solution was transferred to the shallow foil cup using a pipette. The cup was placed under an IR (Infrared) lamp (115 ~ 120° C.) in a fume cupboard, for 30 minutes. Finally, the cup was removed from the IR lamp and cooled to room temperature before reweighed.

| | |
|---|---|
| Weight of Dry Sample | = A |
| Weight of Shallow Foil Cup | = B |
| Weight of Shallow Foil Cup + Dried Contents | = C |
| %TSC of Solvent (W/V) = (C-B) x 100 | = D |
| Total Weight of Dissolved Polymer (in 100 ml) = 100 X D/100 %Gel Content = (1–E/A) x 100 (2) | = E |

$$\% \text{Gel Content =} \left(1 \text{-} \text{E} / \text{A}\right) \times 100 \qquad \text{(2)}$$

### Determination of Viscosity

The latex viscosity was determined at 23° C. using a Brookfield LVT viscometer. Approximately 220 ml of the liquid (freed of air bubbles) was filled into a 250 ml beaker and the spindle of the viscometer was immersed up to the mark on the spindle. The viscometer was then switched-on and after approximately 1 minute the value was recorded until it was constant. The viscosity range determines the choice of spindle and rotational speed and the factor for the recorded value to calculate the viscosity. The information regarding spindle and revolutions per minute used are shown in parenthesis in Examples 1, 2 & 8.

### Determination of the Particle Size (PS)

The z-average particle size was measured using a Malvern Zetasizer Nano S (ZEN 1600) using dynamic light scattering. The latex sample was diluted with deionized water to the turbidity level described in the manual and transferred in the test cuvette. The cuvette was gently mixed to make the sample homogenous and the cuvette was placed in the measurement device. The value was recorded as software generated z-average particle size.

### Dipped Film Preparation

Latex with, or without compounding materials at the desired pH value was stirred for 3 hours at room temperature, and then coagulant dipped as follows,

A ceramic spade or former was washed with soap and then thoroughly rinsed with deionised water before drying in an air-circulating oven set at 65-70° C. (spade temperature, 55-60° C.) until dry.

A solution of coagulant was prepared by dissolving calcium nitrate (18% wt.) and calcium carbonate (2% wt.) in deionised water.

The dry spade or former was then dipped into the salt solution, removed and then dried in an air-circulating oven set at 70-75° C. (spade temperature, 60-65° C.) until dry. The salt-coated spade or former was then dipped into the desired, compounded latex (which has total solid content of 18 wt% and matured for 24 hours at room temperature after compounding) for a dwell time of 5 seconds, before removing it and placing the latex-coated spade or former into an air circulating oven, set at 100° C. for 1 minute, to gel the film.The thus gelled film was then washed in a tank of deionised water set to 50-60° C. for 1 minute, before curing in an air-circulating oven set to 120° C. for 20 minutes; after which, the thus cured/vulcanised film was cooled, and removed from the spade before aging for 22 hours in an air-circulating oven set to 100° C.

Finally, the cured gloves were manually stripped from the spade or former, a typical dried film thickness was 0.056 - 0.066 mm.

The gloves prepared from the latexes were tested for their tensile strength properties.

### Determination of the Tensile Strength Properties on Initial Glove Samples

The tensile properties of the vulcanized gloves were tested in accordance with ISO37-77 (5^{th} Edition 2011-12-15), the dumbbell specimens were cut from gloves prepared from each latex compound using a Type ISO37-2 cutter (width of narrow portion = 4 mm, length of narrow portion = 25 mm, overall length = 75 mm, the thicknesses of the dumbbells are stated in the results Tables) and tested on a Hounsfield HK10KS Tensiometer fitted with H500LC extensometer, at an extension rate of 500 mm/min.

The tensile properties of the vulcanized gloves were also tested in accordance with EN455-2 where the dumbbell specimens were cut from gloves prepared from each latex compound using a Type D cutter (width of narrow portion = 3 mm, length of narrow portion = 33 mm, overall length = 100 mm, the thicknesses of the dumbbells are stated in the results Tables) and tested on a Hounsfield HK10KS Tensiometer fitted with H500LC extensometer, at an extension rate of 500 mm/min. The value for the stress was reported automatically by the machine software, as was the modulus value at a given strain (typically 100, 300 and 500% strain). Both unaged and aged (“aged” refers to specimens which are placed in an oven for 22 hours at 100° C. before tensile properties are tested) results are reported in Table 2 & 3 respectively.

The following abbreviations are used in the Examples

| | | |
|---|---|---|
| MAA | = | methacrylic acid |
| Bd | = | butadiene |
| ACN | = | acrylonitrile |
| GMA | = | glycidyl methacrylate |
| tDDM | = | tert-dodecyl Mercaptan |
| Na₄EDTA | = | tetra sodium salt of ethylenediaminetetraacetic acid |
| tBHP | = | tertiary butyl hydroperoxide |
| TSC | = | total solid content |
| PS | = | particle size |
| ZnO | = | zinc oxide |

In the following all parts and percentages are based on weight unless otherwise specified.

### Example 1: Preparation of Oxirane-Free Carboxylated Nitrile Latex (Low Gel Content)

2 parts by weight (based on polymer solids) of an oxirane-free seed latex (average particle size 36 nm) and 80 parts by weight of water (based on 100 parts by weight of monomer including the seed latex) were added to a nitrogen-purged autoclave and subsequently heated to 30° C. Then 0.01 parts by weight of Na4EDTA and 0.005 parts by weight of Bruggolite FF6 dissolved in 2 parts by weight of water were added, followed by 0.08 parts by weight of sodium persulfate dissolved in 2 parts by weight of water. Then, the monomers (35 parts by weight of acrylonitrile, 58 parts by weight of butadiene, 5 parts by weight of methacrylic acid), and were added together with 0.6 parts by weight of tDDM over a period of 4 hours. Over a period of 10 hours 2.2 parts by weight of sodium dodecyl benzene sulfonate, 0.2 parts by weight of tetra sodium pyrophosphate and 22 parts by weight of water were added. The co-activator feed of 0.13 parts by weight of Bruggolite FF6 in 8 parts by weight of water was added over 9 hours. The temperature was maintained at 30° C. up to a conversion of 95%, resulting in a total solids content of 45%. The polymerization was short-stopped by addition of 0.08 parts by weight of a 5% aqueous solution of diethylhydroxylamine. The pH was adjusted using potassium hydroxide (5% aqueous solution) to pH 7.5 and the residual monomers were removed by vacuum distillation at 60° C. 0.5 parts by weight of a Wingstay L type antioxidant (60% dispersion in water) was added to the raw latex, and the pH was adjusted to 8.2 by addition of a 5% aqueous solution of potassium hydroxide.

The following characterisation results were obtained for Example 1:
TSC = 44.9 wt. %
pH = 8.2
Tg = -18° C.
Gel content = 0%
Viscosity = 38 mPas (1/60)
Particle size, P_{z} = 121 nm

### Example 2: Preparation of Oxirane-Functional Latex

A nitrogen-purged autoclave was charged with 2.0 parts by weight of diphenyl oxide disulfonate dissolved in 185 parts by weight of water relative to 100 parts by weight monomer and heated to a temperature of 70° C. 0.1 parts by weight of tDDM and 0.05 parts by weight of Na4EDTA were added to the initial charge, together with 0.7 parts by weight of ammonium peroxodisulfate (12% solution in water) added in an aliquot addition. Then 45.4 parts by weight of butadiene, 14.6 parts by weight of acrylonitrile and a solution of 5.0 parts by weight of diphenyl oxide disulfonate dissolved in 50 parts by weight of water were added over a period of 6.5 hours. The addition of 40 parts by weight of GMA was started after 1 hour and added over a period of 6.5 hours. After the addition of the monomers the temperature was maintained at 70° C. The polymerization was maintained up to a conversion of 99%. The reaction mixture was cooled to room temperature and sieved through a filter screen (90 µm).

The following characterisation results were obtained for Example 2:
TSC = 37.7 wt. %
pH = 7.1
Tg = -9° C.
Gel content = 96%
Viscosity = 15 mPas (1/60)
Particle size, P_{z} = 39 nm

### Example 3: (Comparative, WO 2017/209596)

To an aliquot of Example 1 (the oxirane-free XNBR latex) was added an aliquot of Example 2 (the oxirane-functional latex), such that the blending ratio was 90:10 by wet weight of Example 1: Example 2.

A portion of the XNBR latex was adjusted to a pH value of 10 using an aqueous solution of potassium hydroxide and compounded with 1 phr zinc oxide and 1 phr titanium dioxide. The compound was then adjusted to a concentration of 18% wt. solids and stirred for 3 hours. A dipped film was prepared as described above.

### Example 4: With 1 Phr Compound (B) (2-hydroxy-l-acryloxy-3-methacryloxy Propane), without ZnO

To an aliquot of Example 1 (the oxirane-free XNBR latex) was added an aliquot of 1 phr of 2-hydroxy-1-aryloxy-3-methacryloxy propane and stirred well for 2 hours.

The latex was adjusted to a pH value of 10 using a solution of potassium hydroxide and compounded before it was dipped with a dry, salt-coated spade and processed in accordance with the protocol given in Example 3, except that no zinc oxide was added.

### Example 5: With 1 Phr Compound (B) (2-hydroxy-1-acryloxy-3-methacryloxy Propane), With ZnO

To an aliquot of Example 1 (the oxirane-free XNBR latex) was added an aliquot of 1 phr of 2-hydroxy-1-aryloxy-3-methacryloxy propane and stirred well for 2 hours.

The latex was adjusted to a pH value of 10 using a solution of potassium hydroxide and compounded before it was dipped with a dry, salt-coated spade and processed in accordance with the protocol given in Example 3.

### Example 6: With 2 Phr Compound (B) (2-hydroxy-1-acryloxy-3-methacyloxy Propane), Wth ZnO

Same as Example 5, except 2 phr of 2-hydroxy-1-acryloxy-3-methacryloxy propane was added.

### Example 7: With 3 Phr Compound (B) (2-hydroxy-1-acryloxy-3-methacyloxy Propane), With ZnO

Same as Example 5, except 3 phr of 2-hydroxy-1-acryloxy-3-methacryloxy propane was added.

### Example 8: With 5 Phr Compound (B) (2-hydroxy-1-acryloxy-3-methacyloxy Propane), With ZnO

Same as Example 5, except 5 phr of 2-hydroxy-1-acryloxy-3-methacryloxy propane was added.

Gel content data for some of the latex samples prior to dipping are summarized in Table 1.

TABLE 1

| Latex | Gel content (%) |
|---|---|
| Example 1 | 10 |
| Example 2 | 97 |
| Example 3 | 45 |
| Example 7 | 21 |

Tensile strength data for the as-prepared films were measured as described above and are summarized in Tables 2 and 3.

TABLE 2

Unaged result for Examples 3-8

| Patent Examples | ASTM | | | | | | EN | |
|---|---|---|---|---|---|---|---|---|
| | Thickness (mm) | Tensile Strength (MPa) | Elongation at break (%) | Modulus (MPa) | | | Thickness (mm) | Force at Break (N) |
| | | | | 100 | 300 | 500 | | |
| Example 3 | 0.066 | 27.8 | 591 | 2.3 | 5.2 | 13.6 | 0.066 | 6.6 |
| Example 4 | 0.058 | 20.7 | 756 | 1.4 | 2.4 | 4.0 | 0.057 | 5.4 |
| Example 5 | 0.069 | 28.9 | 645 | 2.0 | 3.9 | 8.9 | 0.067 | 7.6 |
| Example 6 | 0.066 | 28.5 | 665 | 1.9 | 3.4 | 7.4 | 0.061 | 7.0 |
| Example 7 | 0.069 | 25.6 | 682 | 1.7 | 3.1 | 6.4 | 0.067 | 7.0 |
| Example 8 | 0.067 | 26.8 | 713 | 1.7 | 2.9 | 5.8 | 0.067 | 6.4 |

TABLE 3

Aged result for Examples 3-8

| Patent Examples | ASTM | | | | | | EN | |
|---|---|---|---|---|---|---|---|---|
| | Thickness (mm) | Tensile Strength (MPa) | Elongation at break (%) | Modulus (MPa) | | | Thickness (mm) | Force at Break (N) |
| | | | | 100 | 300 | 500 | | |
| Example 3 | 0.065 | 36.2 | 525 | 3.1 | 9.1 | 30.9 | 0.070 | 7.9 |
| Example 4 | 0.062 | 25.6 | 740 | 1.4 | 2.4 | 4.5 | 0.066 | 5.9 |
| Example 5 | 0.072 | 36.8 | 652 | 2.2 | 4.3 | 10.1 | 0.073 | 9.2 |
| Example 6 | 0.068 | 40.0 | 657 | 2.2 | 4.5 | 10.4 | 0.065 | 8.9 |
| Example 7 | 0.073 | 34.0 | 657 | 2.0 | 4.0 | 9.1 | 0.072 | 8.8 |
| Example 8 | 0.068 | 33.3 | 668 | 1.9 | 3.4 | 7.8 | 0.073 | 8.3 |

As shown in Table 2, elongation at break was enhanced from 645% to 713% when level of 2-hydroxy-1-acryloxy-3-methacryloxy propane was increased from 1 phr to 5 phr. The softness effect from the crosslinker was confirmed by also the corresponding reduction of the 300% modulus from 3.9 MPa to 2.9 MPa. It is noted that without ZnO in the compounding formulation, both tensile strength and force at break dropped significantly. Similar trend was also observed from aged result as shown in Table 3 where the highest elongation at break and the lowest 300% modulus were achieved with use of 5 phr of compound (B) in the presence of ZnO.

### Example 9: Preparation of Oxirane-Free Carboxylated Nitrile Latex

2 parts by weight (based on polymer solids) of an oxirane-free seed latex (average particle size 36 nm) and 80 parts by weight of water (based on 100 parts by weight of monomer including the seed latex) were added to a nitrogen-purged autoclave and subsequently heated to 30° C. Then 0.01 parts by weight of Na4EDTA, 0.005 parts by weight of Bruggolite FF6 dissolved in 2 parts by weight of water and 0.3 part by weight of tDDM were added, followed by 0.08 parts by weight of sodium persulfate dissolved in 2 parts by weight of water. Then, the monomers (35 parts by weight of acrylonitrile, 56 parts by weight of butadiene, 7 parts by weight of methacrylic acid), and were added together with 0.45 parts by weight of tDDM over a period of 6 hours except 4.5 hours for the tDDM. Over a period of 10 hours 2.2 parts by weight of sodium dodecyl benzene sulfonate, 0.2 parts by weight of tetra sodium pyrophosphate and 22 parts by weight of water were added. The co-activator feed of 0.13 parts by weight of Bruggolite FF6 in 8 parts by weight of water was added over 9 hours. The temperature was maintained at 30° C. up to a conversion of 95 %, resulting in a total solids content of 45%. The polymerization was short-stopped by addition of 0.08 parts by weight of a 5 % aqueous solution of diethylhydroxylamine. The pH was adjusted using potassium hydroxide (5 % aqueous solution) to pH 7.5 and the residual monomers were removed by vacuum distillation at 60° C. 0.5 parts by weight of a Wingstay L type antioxidant (60% dispersion in water) was added to the raw latex, and the pH was adjusted to 8.2 by addition of a 5% aqueous solution of potassium hydroxide.

The following characterisation results were obtained for Example 9:
TSC = 44.5 wt. %
pH = 8.3
Tg = -13° C.
Viscosity = 50 mPas (1/60)
Particle size, P_{z} = 127 nm

### Example 10: (comparative)

To an aliquot of Example 9 (the oxirane-free XNBR latex) was added an aliquot of Example 2 (the oxirane-functional latex), such that the blending ratio was 90:10 by wet weight of Example 9: Example 2.

A portion of the XNBR latex was adjusted to a pH value of 9.5 using an aqueous solution of potassium hydroxide and compounded with 1 phr zinc oxide and 1 phr titanium dioxide. The compound was then adjusted to a concentration of 18% wt. solids and stirred for 3 hours.

A dry, salt-coated former was dipped into the compounded latex solution before the film was gelled at 100° C. for 1 minute, washed with deionised water for 1 minute (in a tank set at 50-60° C.) for 1 minutes, followed by drying and curing/vulcanisation in an air-circulating oven set at 120° C. for 20 minutes, to ensure complete drying and crosslink formation. A dipped film was prepared as described above.

### Example 11: With 1 Phr Compound (B) (2-hydroxy-1-acryloxy-3-methacryloxy Propanep

To an aliquot of Example 15 (the oxirane-free XNBR latex) was added an aliquot of 1 phr of 2-hydroxy-1-aryloxy-3-methacryloxy propane and stirred well for 2 hours.

The latex was adjusted to a pH value of 9.5 using a solution of potassium hydroxide and compounded before it was dipped with a dry, salt-coated former and processed in accordance with the protocol given in Example 10.

### Example 12: (comparative)

To an aliquot of Example 9 (the oxirane-free XNBR latex) was added an aliquot of Example 2 (the oxirane-functional latex), such that the blending ratio was 90:10 by wet weight of Example 9: Example 2.

A portion of the XNBR latex was adjusted to a pH value of 9.5 using an aqueous solution of potassium hydroxide and compounded with 1 phr zinc oxide and 1 phr titanium dioxide. The compound was then adjusted to a concentration of 18% wt. solids and stirred for 3 hours. A dipped film was prepared as described above, with the exception that the curing temperature was 70° C. instead of 120° C.

### Example 13: With 1 Phr Compound (B) (2-hydroxy-1-acryloxy-3-methacryloxy Propane)

To an aliquot of Example 9 (the oxirane-free XNBR latex) was added an aliquot of 1 phr of 2-hydroxy-1-aryloxy-3-methacryloxy propane and stirred well for 2 hours.

The latex was adjusted to a pH value of 9.5 using a solution of potassium hydroxide and compounded before it was dipped with a dry, salt-coated former and processed in accordance with the protocol given in Example 12.

The tensile properties of the vulcanized gloves were tested as described above. Both unaged and aged results are reported in Table 4 & 5 respectively.

TABLE 4

Unaged result for Examples 10-13

| Patent Examples | ASTM | | | | | | EN | |
|---|---|---|---|---|---|---|---|---|
| | Thickness (mm) | Tensile Strength (MPa) | Elongation at break (%) | Modulus (MPa) | | | Thickness (mm) | Force at Break (N) |
| | | | | 100 | 300 | 500 | | |
| Example 10 | 0.053 | 36.5 | 556 | 2.3 | 6.1 | 24.4 | 0.052 | 6.4 |
| Example 11 | 0.048 | 37.4 | 640 | 2.0 | 4.3 | 13.1 | 0.047 | 5.5 |
| Example 12 | 0.057 | 32.3 | 572 | 2.2 | 5.2 | 18.9 | 0.049 | 5.6 |
| Example 13 | 0.052 | 30.2 | 587 | 1.9 | 4.2 | 12.8 | 0.049 | 6.2 |

TABLE 5

Aged result for Examples 10-13

| Patent Examples | ASTM | | | | | | EN | |
|---|---|---|---|---|---|---|---|---|
| | Thickness (mm) | Tensile Strength (MPa) | Elongation at break (%) | Modulus (MPa) | | | Thickness (mm) | Force at Break (N) |
| | | | | 100 | 300 | 500 | | |
| Example 10 | 0.049 | 41.9 | 510 | 2.5 | 8.5 | 34.9 | 0.055 | 7.5 |
| Example 11 | 0.052 | 41.8 | 620 | 2.0 | 4.4 | 15.3 | 0.050 | 7.5 |
| Example 12 | 0.055 | 39.5 | 521 | 2.6 | 8.5 | 33.5 | 0.057 | 8.4 |
| Example 13 | 0.051 | 41.2 | 635 | 2.1 | 4.4 | 12.6 | 0.053 | 7.5 |

As shown in Table 4, elongation at break for samples with 2-hydroxy-1-acryloxy-3-methacryloxy propane was higher than their respective comparative examples. For instance, Example 11 exhibited elongation at break of 640%, which is significantly higher than the 556% of the comparative Example 10. Not only elongation at break, the softness effect from 2-hydroxy-1-acryloxy-3-methacryloxy propane was evidenced by the lower 300% and 500% modulus for all samples i.e. Examples 11 and 13 for both unaged result in Table 4 and aged result in Table 5. Also, it was surprisingly found that the 2-hydroxy-1-acryloxy-3-methacryloxy propane offered good lower curing temperature performance, even for ultrathin gloves. For instance, gloves from Example 13 achieved a force at break of at least 6 Newtons at very low glove thickness of <0.050 mm.

1. A polymer latex for the preparation of elastomeric films comprising:
(A) particles of a latex polymer (A) obtainable by free-radical emulsion polymerization of a mixture of ethylenically unsaturated monomers the latex polymer comprising a plurality of functional groups (x); and
(B) a compound bearing a beta-hydroxy ester linkage and at least one additional functional group (y) reactive with the functional groups (x) on latex polymer (A).

2. The latex polymer of claim 1, wherein the functional groups (x) on the latex polymer (A) are selected from groups having a carbon-carbon double bond, carboxylic acid functional groups, hydroxyl, epoxy, acetoacetyl, primary or secondary amino, acetoxy, isocyanato, alkoxysilyl, alkoxy, dioxolanone functional groups and combinations thereof.

3. The latex polymer of claim 1 wherein the monomer composition for the latex polymer (A) comprises
(a) 15 to 99 wt.-% of conjugated dienes;
(b) 1 to 80 wt.-% of monomers selected from ethylenically unsaturated nitrile compounds;
(c) 0 to 10 wt.-% of an ethylenically unsaturated compound different from conjugated dienes bearing a functional group (x);
(d) 0 to 80 wt.-% of vinyl aromatic monomers; and
(e) 0 to 65 wt.-% of alkyl esters of ethylenically unsaturated acids,
the weight percentages being based on the total weight of monomers in the monomer mixture.

4. The polymer latex of claim 3 wherein
(a) the conjugated dienes are selected from butadiene, isoprene, 2,3-dimethyl-1,3-butadiene, 2-ethyl-1,3-butadiene, 1,3-pentadiene and combinations thereof;
(b) the ethylenically unsaturated nitrile compounds are selected from (meth)acrylonitrile, alpha-cyanoethyl acrylonitrile, fumaronitrile, alpha-chloronitrile and combinations thereof;
(c) the ethylenically unsaturated compounds different from conjugated dienes bearing a functional group (x) are selected from
(c1) ethylenically unsaturated compounds having at least two different ethylenically unsaturated groups;
(c2) ethylenically unsaturated acids and salts thereof;
(c3) hydroxy functional ethylenically unsaturated compounds;
(c4) oxirane functional ethylenically unsaturated compounds;
(c5) acetoacetyl functional ethylenically unsaturated compounds;
(c6) ethylenically unsaturated compounds bearing a primary or secondary amino group;
(c7) acetoxy functional ethylenically unsaturated compounds;
(c8) isocyanato functional ethylenically unsaturated compounds;
(c9) alkoxysilyl functional ethylenically unsaturated compounds;
(c10) alkoxy functional ethylenically unsaturated compounds;
(c11) dioxolanone functional ethylenically unsaturated compounds;
and combinations thereof;
(d) the vinyl aromatic monomers are selected from styrene, alpha-methyl styrene and combinations thereof;
(e) alkyl esters of ethylenically unsaturated acids are selected from methyl (meth)acrylate, ethyl (meth)acrylate, propyl (meth)acrylate, butyl (meth)acrylate, 2-ethylhexyl (meth)acrylate;
and combinations thereof;
the mixture of ethylenically unsaturated monomers for latex polymer (A) optionally comprises ethylenically unsaturated monomers selected from
(f) vinyl carboxylates;
(g) monomers having at least two identical ethylenically unsaturated groups; and
combinations thereof.

5. The polymer latex of claim 1, wherein the mixture of ethylenically unsaturated monomers for latex polymer (a) comprises:
20 to 99 wt.-% of conjugated dienes;
1 to 60 wt.-% of monomers selected from ethylenically unsaturated nitrile compounds;
0 to 70 wt.-% of vinyl aromatic monomers;
0 to 25 wt.-% of C₁ to C₈ alkyl (meth)acrylates;
0.05 to 7 wt.-% of ethylenically unsaturated acids; and
0 to 10 wt.-% of vinyl esters:
the weight percentages being based on the total weight of monomers in the monomer mixture.

6. The polymer latex of claim 1, wherein the functional groups (y) in compound (B) reactive with the functional groups (x) on latex polymer (A) are selected from carbon-carbon double bonds, epoxy, thiol, hydroxy, primary or secondary amino, isocyanato, oxazolino, aziridino, imino, carbodiimido, glycol groups, ester groups, acetoxy, carboxylic acid groups, alkoxy silyl groups, dioxolanone groups, hydrazido, and combinations thereof.

7. The polymer latex of claim 1, wherein the functional groups (y) in compound (B) are in a terminal position.

8. The polymer latex of claim 1, wherein
the functional groups (x) are selected from groups having a carbon-carbon double bond and the functional groups (y) are selected from groups having carbon-carbon double bonds and thiol; or
the functional groups (x) are selected from carboxylic acid functional groups and the functional groups (y) are selected from epoxy, thiol, hydroxy, primary or secondary amino, isocyanato, oxazolino, aziridino, imino, carbodiimido, glycol groups, ester groups, and acetoxy; or
the functional groups (x) are selected from hydroxyl and the functional groups (y) are selected from alkoxysilyl, carboxylic acid functional groups; isocyanato, primary or secondary amino, and ester groups; or
the functional groups (x) are selected from epoxy and the functional groups (y) are selected from carboxylic acid functional groups, hydroxyl and ester groups; or
the functional groups (x) are selected from acetoacetyl and the functional groups (y) are selected from groups having carbon-carbon double bonds, isocyanato and primary or secondary amino; or
the functional groups (x) are selected from primary or secondary amino and the functional groups (y) are selected from carboxylic acid functional groups, epoxy, ester groups and dioxolanone groups; or
the functional groups (x) are selected from acetoxy and the functional groups (y) are selected from hydrazido and primary or secondary amino; or
the functional groups (x) are selected from isocyanato and the functional groups (y) are selected from carboxylic acid functional groups. hydroxyl, primary or secondary amino and thiol; or
the functional groups (x) are selected from alkoxysilyl and the functional groups (y) are selected hydroxyl and alkoxysilyl; or
the functional groups (x) are selected from alkoxy and the functional groups (y) are selected from ester groups; or
the functional groups (x) are selected from ester groups and the functional groups (y) are selected from hydroxyl, carboxylic acid groups and ester groups; or
the functional groups (x) are selected from dioxolanone groups and the functional groups (y) are selected from primary or secondary amino.

9. The polymer latex of claim 1, wherein compound (B) is selected from glycerol dimethacrylate (GDMA), glycerol 1,3-diglycerolate diacrylate (GDGDA), 3-(acryloyloxy)-2-hydroxypropyl methacrylate, bisphenol A glycerolate diacrylate, levulinic acid methacrylate (KEMA), glyceryl monomethacrylate, fatty acid modified glycidyl methacrylate Bisphenol A glycerolate diacrylate, 2-hydroxy-3-phenoxypropyl (meth) acrylate, eugenyl-2-hydroxypropyl methacrylate and combinations thereof.

10. The polymer latex of claim 1, wherein the particles of latex polymer (A) are present in amounts of 80 to 99.9 wt.-% and compound (B) is present in amounts of 0.1 to 20 wt. based on the total weight of latex polymer (A) and compound (B).

11. A method for preparation of a polymer latex comprising
(i) polymerizing in an emulsion polymerization process a mixture of ethylenically unsaturated monomers for latex polymer (A) comprising at least one monomer resulting after polymerization in a functional group (x) to obtain a latex comprising particles of latex polymer (A) bearing a plurality of functional groups (x); and
(ii) adding a compound (B) bearing a beta-hydroxy ester linkage and at least one additional functional group (y) reactive with the functional groups (x) on latex polymer (A).

12. The method of claim 11, wherein the functional groups (x) on the latex polymer (A) are selected from groups having a carbon-carbon double bond, carboxylic acid functional groups, hydroxyl, epoxy, acetoacetyl, primary or secondary amino, acetoxy, isocyanato, alkoxvsilvl, alkoxy, dioxolanone functional groups and combinations thereof, and wherein the at least one additional functional group (y) is selected from carbon-carbon double bonds, epoxy, thiol, hydroxy, primary or secondary amino, isocyanato, oxazolino, aziridino, imino, carbodiimido, glycol groups, ester groups, acetoxy, carboxylic acid groups, alkoxy silyl groups, dioxolanone groups, hydrazido, and combinations thereof.

13. Use of the polymer latex according to claim 1 for the production of elastomeric articles or for coating or impregnating a substrate.

14. A compounded latex composition suitable for the production of dip-molded articles comprising the polymer latex according to claim 1 and optionally adjuvants selected from sulfur vulcanization agents, accelerators for sulfur vulcanization, polyvalent cations, free-radical initiators and combinations thereof.

15. The compounded latex composition of claim 14, being free of sulfur vulcanization agents and accelerators for sulfur vulcanization and optionally comprising polyvalent cations.

16. A method for making dip-molded articles by
a) providing a compounded latex composition of claim 14;
b) immersing a mold having the desired shape of the final article in a coagulant bath comprising a solution of a metal salt;
c) removing the mold from the coagulant bath and optionally drying the mold;
d) immersing the mold as treated in step b) and c) in the compounded latex composition of step a);
e) coagulating a latex film on the surface of the mold;
f) removing the latex-coated mold from the compounded latex composition and optionally immersing the latex-coated mold in a water bath;
g) optionally drying the latex-coated mold;
h) heat treating the latex-coated mold obtained from step e) or f) at a temperature of 40° C. to 180° C.; and/or exposing the latex-coated mold obtained from step e) or f) to UV radiation;
i) removing the latex article from the mold.

17. A method for making elastomeric articles comprising:
obtaining a continuous elastomeric film from the polymer latex according to claim 1;
optionally heat treating the continuous elastomeric film and/or exposing the continuous elastomeric film to UV radiation;
aligning two separate continuous elastomeric films;
cutting or stamping the aligned continuous elastomeric films into a preselected shape to obtain two superposed layers of the elastomeric films in the preselected shape;
joining together the superposed layers at at least a preselected part of the periphery to form an elastomeric article.

18. The method of claim 17, wherein the joining together is performed by using thermal means.

19. An article made by using the polymer latex according to claim 1.

20. The article of claim 19, being selected from surgical gloves, examination gloves, condoms, catheters, industrial gloves, textile-supported gloves, household gloves balloons and tubing.
